(19) United States
(12) Patent Application Publication
(10) Pub. No.: US 2014/0232625 A1
(43) Pub. Date: Aug. 21, 2014

(54) CORRECTION DATA GENERATION METHOD, CORRECTION DATA GENERATION SYSTEM, AND IMAGE QUALITY ADJUSTMENT TECHNIQUE USING THE METHOD AND SYSTEM

(71) Applicant: IIX INC., Tokyo (JP)

(72) Inventors: Hiroshi MURASE, Tokyo (JP); Masayoshi IMOTO, Tokyo (JP)

(73) Assignee: IIX INC., Tokyo (JP)

(21) Appl. No.: 13/833,966

(22) Filed: Mar. 15, 2013

Related U.S. Application Data
(63) Continuation of application No. PCT/JP2013/053919, filed on Feb. 19, 2013.

(51) Int. Cl. G09G 3/36

(52) U.S. Cl. CPC G09G 3/3607
USPC 345/89

(57) ABSTRACT

Provided is a correction data generation method that can generate highly accurate correction data while suppressing the influence of photon shot noise. According to the correction data generation method of the present invention, test patterns are displayed on a liquid crystal panel (2) in units of specific gradation values, the displayed test patterns are captured by a camera (3) a plurality of times for each specific gradation value, and a summed image is generated for each specific gradation value by summing a plurality of captured images of the test patterns. Based on the summed image for each specific gradation value, correction data is generated for reducing unevenness in display of the liquid crystal panel (2) through correction of a signal input to the liquid crystal panel (2).

### CROSS REFERENCE TO RELATED APPLICATIONS

This Application is continuation of and claims the benefit of priority from the prior PCT Application No. PCT/JP2013/053919, filed. on Feb. 19, 2013, the entire contents of which are incorporated herein by reference.

### TECHNICAL FIELD

The present invention relates to a correction data generation method and a correction data generation system that capture a display panel with a camera so as to generate correction data for reducing unevenness in display of the display panel through correction of a signal input to the display panel, and also relates to an image quality adjustment technique using such method and system.

### BACKGROUND ART

It is commonly known that a liquid crystal panel, an organic EL panel and similar display panels exhibit unevenness in display, such as luminance unevenness and color unevenness, due to manufacturing variations such as unevenness in cell gaps and unevenness in the brightness of a backlight. When each pixel in a display panel has RGB display elements, unevenness in luminance occurs if a relative relationship among R, G and B in each individual pixel in terms of brightness does not vary but the absolute brightness varies between neighboring pixels, and unevenness in color occurs if a relative relationship among R, G and B in each individual pixel in terms of brightness varies between neighboring pixels.

There are techniques to improve the image quality of a display panel by reducing such unevenness in display. One example is an image correction data generation system described in PTL 1. This system displays a gray image across the entire display panel, calculates the luminance distribution of the gray image by capturing the gray image with a camera, and generates correction data based on the luminance distribution. The generated correction data is stored in a correction circuit provided in the display panel. When an image signal is input to the display panel, the correction circuit corrects the input signal based on the correction data. As a result, unevenness in display is reduced.

### CITATION LIST

### Patent Literature

[PLT1] JP 2010-57149A

### SUMMARY OF INVENTION

### Technical Problem

When a display panel is captured by a camera including a solid-state imaging device, a captured image includes noise mainly composed of photon shot noise. More specifically, considering that light consists of unconnected discrete photons and is quantized in units of photons, light to which each pixel in the camera is exposed consists of unconnected discrete photons and is quantized. When the number of photons that randomly hit each pixel varies among different pixels (when there are both pixels hit by a large number of photons and pixels hit by a small number of photons by chance), a captured image includes noise.

This noise is an unavoidable phenomenon caused by the movement of photons, and is therefore difficult to remove through improvement of the camera. When such noise in a captured image is erroneously recognized as constituting unevenness in display of the display panel, generation of highly accurate correction data is inhibited.

The present invention has been made in view of the above problem, and aims to provide a correction data generation method and a correction data generation system that can generate highly accurate correction data while suppressing the influence of photon shot noise, and to provide an image quality adjustment technique using such method and system.

### Solution to Problem

In order to solve the above problem, the invention according to Claim 1 is a correction data generation method for generating correction data by capturing a display panel with a camera, the correction data being for reducing unevenness in display of the display panel by correcting a signal input to the display panel. The method includes: a capturing step of displaying test patterns on the display panel in units of specific gradation values, and capturing the test patterns with the camera a plurality of times for each specific gradation value; a summed image generating step of generating, for each specific gradation value, a summed image by summing a plurality of captured images of the test patterns; and a correction data generating step of generating the correction data for each specific gradation value based on the corresponding summed image.

The invention according to Claim 2 is the correction data generation method according to Claim 1 wherein the number of times the test patterns are captured for each specific gradation value is either the same between any two sequential gradation values, or larger for one of the sequential gradation values that has higher luminance than for the other that has lower luminance.

The invention according to Claim 3 is the correction data generation method according to Claim 1 wherein three or more gradation values are set as the specific gradation values, and a difference between any two sequential gradation values is either the same between two consecutive pairs of sequential gradation values, or larger for one of the consecutive pairs that has higher luminance than for the other that has lower luminance.

The invention according to Claim 4 is a correction data generation system for generating correction data by capturing a display panel with a camera, the correction data being for reducing unevenness in display of the display panel by correcting a signal input to the display panel. The system includes: a display control means that displays test patterns on the display panel in units of specific gradation values; a summed image generation means that generates a summed image for each specific gradation value by summing a plurality of captured images obtained by the camera capturing the test patterns a plurality of times for each specific gradation value: and a correction data generation means that generates the correction data for each specific gradation value based on the corresponding summed image.

The invention according to Claim 5 is the correction data generation system according to Claim 4 wherein the number of times the test patterns are captured for each specific gradation value is either the same between any two sequential gradation values, or larger for one of the sequential gradation values that has higher luminance than for the other that has lower luminance.

The invention according to Claim 6 is the correction data generation system according to Claim 4 wherein three or more gradation values are set as the specific gradation values, and a difference between any two sequential gradation values is either the same between two consecutive pairs of sequential gradation values, or larger for one of the consecutive pairs that has higher luminance than for the other that has lower luminance.

The invention according to Claim 7 is an image quality adjustment method for adjusting image quality of a display panel using correction data for reducing unevenness in display of the display panel through correction of a signal input to the display panel. The method includes: a capturing step of displaying test patterns on the display panel in units of specific gradation values, and capturing the test patterns with the camera a plurality of times for each specific gradation value; a summed image generating step of generating, for each specific gradation value, a summed image by summing a plurality of captured images of the test patterns; a correction data generating step of generating the correction data for each specific gradation value based on the corresponding summed image; and an input signal correcting step of correcting the signal input to the display panel based on the correction data.

The invention according to Claim 8 is the image quality adjustment method according to Claim 7 wherein the number of times the test patterns are captured for each specific gradation value is either the same between any two sequential gradation values, or larger for one of the sequential gradation values that has higher luminance than for the other that has lower luminance.

The invention according to Claim 9 is the image quality adjustment method according to Claim 7 wherein three or more gradation values are set as the specific gradation values, and a difference between any two sequential gradation values is either the same between two consecutive pairs of sequential gradation values, or larger for one of the consecutive pairs that has higher luminance than for the other that has lower luminance.

The invention according to Claim 10 is a method for manufacturing a display panel with image quality adjustment functions including a display panel and an image quality adjustment means provided with a storage having stored therein correction data for reducing unevenness in display of the display panel through correction of a signal input to the display panel. The method includes: a capturing step of displaying test patterns on the display panel in units of specific gradation values, and capturing the test patterns with the camera a plurality of times for each specific gradation value; a summed image generating step of generating, for each specific gradation value, a summed image by summing a plurality of captured images of the test patterns; a correction data generating step of generating the correction data for each specific gradation value based on the corresponding summed image; a correction data storing step of storing the correction data in the storage; and a mounting step of mounting the image quality adjustment means on the display panel so that the image quality adjustment means corrects the signal input to the display panel based on the correction data.

The invention according to Claim 11 is the method for manufacturing the display panel with image quality adjustment functions according to Claim 10 wherein the number of times the test patterns are captured for each specific gradation value is either the same between any two sequential gradation values, or larger for one of the sequential gradation values that has higher luminance than for the other that has lower luminance.

The invention according to Claim 12 is the method for manufacturing the display panel with image quality adjustment functions according to Claim 10 wherein three or more gradation values are set as the specific gradation values, and a difference between any two sequential gradation values is either the same between two consecutive pairs of sequential gradation values, or larger for one of the consecutive pairs that has higher luminance than for the other that has lower luminance.

The invention according to Claim 13 is a display panel with image quality adjustment functions including a display panel and an image quality adjustment means provided with a storage having stored therein correction data for reducing unevenness in display of the display panel through correction of a signal input to the display panel. Test patterns are displayed on the display panel in units of specific gradation values, the test patterns are captured by a camera a plurality of times for each specific gradation value, a summed image is generated for each specific gradation value by summing a plurality of captured images of the test patterns, and the correction data is generated for each specific gradation values based on the corresponding summed image.

The invention according to Claim 14 is the display panel with image quality adjustment functions according to Claim 13 wherein the number of times the test patterns are captured for each specific gradation value is either the same between any two sequential gradation values, or larger for one of the sequential gradation values that has higher luminance than for the other that has lower luminance.

The invention according to Claim 15 is the display panel with image quality adjustment functions according to Claim 13 wherein three or more gradation values are set as the specific gradation values, and a difference between any two sequential gradation values is either the same between two consecutive pairs of sequential gradation values, or larger for one of the consecutive pairs that has higher luminance than for the other that has lower luminance.

With the invention according to Claim 1 or 4, test patterns are displayed on the display panel in units of specific gradation values, the displayed test patterns are captured by the camera a plurality of times for each specific gradation value, a summed image is generated for each specific gradation value by summing a plurality of captured images of the test patterns, and correction data is generated for each specific gradation value based on the corresponding summed image. As a result, highly accurate correction data can be generated while suppressing the influence of photon shot noise.

More specifically, provided that the average number of electrons generated in each pixel in the camera is m, it is known that the amount of random noise is √m, and the S/N ratio (SNR) is m/√m=√m. Therefore, in the case where the summation is performed n times, the S/N ratio is SNRn=(m×n)/√(m×n)=√(m×n)=√m×√n=SNR×√n, hence improved by in times compared to the case where the summation is not performed.

Therefore, the S/N ratio of a summed, image is √n times larger than the S/N ratio of a captured image obtained through single image capture. As correction data is generated based on such a summed image that has a large S/N ratio, highly accurate correction data can be obtained while suppressing the influence of photon shot noise.

Although it is possible to improve the S/N ratio of a captured image by, for example, increasing the number of saturated electrons using a large light receiving element in the camera (increasing m in the above equations) so as to obtain correction data with high luminance based on such a captured image, this method is costly because a large light receiving element is normally expensive. On the other hand, when a summed image is generated by summing a plurality of captured images in the above manner, the number of saturated electrons can be practically increased without using a large light receiving element, and therefore the accuracy of the correction data can be improved.

With the invention according to Claim 2 or 5, the number of times the test patterns are captured for each specific gradation value is either the same between any two sequential gradation values, or larger for one of the sequential gradation values that has higher luminance than for the other that has lower luminance. In this way, while the test patterns are captured a larger number of times for higher luminance that requires a short period of time for exposure and image capture, the test patterns are captured a smaller number of times for lower luminance that requires a long period of time for image capture. Consequently, the increase in the takt time due to repetition of image capture can be suppressed.

The characteristics of noise are such that noise occurs at a fixed rate with respect to luminance, and is easily visible for high luminance and is not easily visible for low luminance. Therefore, although the increase in the takt time is suppressed by capturing the test patterns a larger number of times for higher luminance and a smaller number of times for lower luminance, the effect of reducing noise through summation can be achieved adequately

With the invention according to Claim 3 or 6, three or more gradation values are set as the specific gradation values, and a difference between any two sequential gradation values is either the same between two consecutive pairs of sequential gradation values, or larger for one of the consecutive pairs that has higher luminance than for the other that has lower luminance. In this way, the interval of image capture (the interval of luminance) is smaller for lower luminance that easily changes the form and distribution of unevenness in display when the luminance changes. Accordingly, even when correction data is calculated through interpolation for gradation values for which image capture is not performed, highly accurate correction data can be obtained.

With the invention according to Claim 7, 10 or 13, similarly to the invention according to Claim 1 or 4, test patterns are displayed on the display panel in units of specific gradation values, the displayed test patterns are captured by the camera a plurality of times for each specific gradation value, a summed image is generated for each specific gradation value by summing a plurality of captured images of the test patterns, and correction data is generated for each specific gradation value based on the corresponding summed image. As a result, highly accurate correction data can be generated while suppressing the influence of photon shot noise.

As a signal input to the display panel is corrected based on such correction data, unevenness in display of the display panel can be reduced effectively, and the image quality thereof can be adjusted with high accuracy and thus be improved.

With the invention according to Claim 8, 11 or 14, similarly to the invention according to Claim 2 or 5, the number of times the test patterns are captured for each specific gradation value is either the same between any two sequential gradation values, or larger for one of the sequential gradation values that has higher luminance than for the other that has lower luminance. In this way, while the test patterns are captured a larger number of times for higher luminance that requires a short period of time for image capture and. makes noise easily prominent, the test patterns are captured a smaller number of times for lower luminance that requires a long period of time for image capture and makes noise less prominent. Consequently, correction data that adequately has the effect of reducing noise through summation can be generated while suppressing the increase in the takt time.

Furthermore, as the signal input to the display panel is corrected based on such correction data, the image quality of the display panel can be improved.

With, the invention according to Claim 9, 12 or 15, similarly to the invention according to Claim 3 or 6, three or more gradation values are set as the specific gradation values, and a difference between any two sequential gradation values is either the same between two consecutive pairs of sequential gradation values, or larger for one of the consecutive pairs that has higher luminance than for the other that has lower luminance. In this way, the interval of image capture (the interval of luminance), is smaller for lower luminance that easily changes the form and distribution of unevenness in display when the luminance changes. Accordingly, even when correction data is calculated through interpolation for gradation values for which image capture is not performed, highly accurate correction data can be obtained.

Furthermore, as the signal input to the display panel is corrected based on such correction data, the image quality of the display panel can be improved.

### Advantageous Effects of Invention

The present invention allows generating highly accurate correction data while suppressing the influence of photon shot noise, thereby improving the image quality of a display panel.

### BRIEF DESCRIPTION OF DRAWINGS

FIG. 1 illustrates a correction data generation system pertaining to embodiments of the invention.

FIG. 2 is a flowchart showing the first half of processing of a correction data generation method, a method for manufacturing a display panel with image quality adjustment functions, and an image quality adjustment method pertaining to Embodiment 1.

FIG. 3 is a flowchart showing the second half of the processing of the correction data generation method, the method for manufacturing the display panel with image quality adjustment functions, and the image quality adjustment method pertaining to Embodiment 1.

FIG. 4 is a flowchart of a correction data generation method, a method for manufacturing a display panel with image quality adjustment functions, and an image quality adjustment method pertaining to Embodiment 2.

### DESCRIPTION OF EMBODIMENTS

The following describes embodiments of the present invention with reference to the drawings.

### Embodiment 1

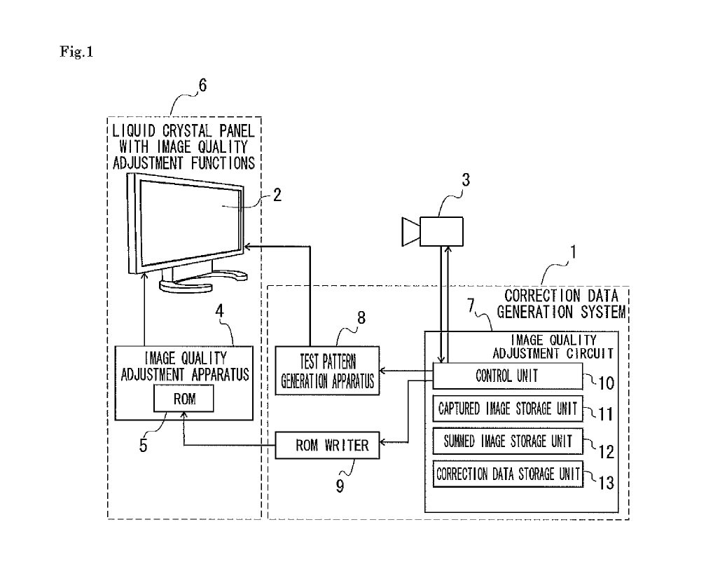

FIG. 1 illustrates a correction data generation system pertaining to the present embodiment. A correction data generation system 1 displays test patterns on a liquid crystal panel 2, captures the displayed test patterns with a black-and-white camera 3 including a solid-state imaging device, and generates correction data for reducing unevenness in display of the liquid crystal panel 2. The generated correction data is stored in a ROM (non-volatile memory) 5 in an image quality adjustment circuit 4. A liquid crystal panel 6 with image quality adjustment functions is manufactured by mounting this image quality adjustment circuit 4 on the liquid crystal panel 2. In the liquid crystal panel 6 with image quality adjustment functions, the image quality adjustment circuit 4 corrects an image signal input to the liquid crystal panel 2 (input signal) with reference to the correction data stored in the ROM 5. As a result, unevenness in display of the liquid crystal panel 2 is reduced, and the image quality is adjusted.

The correction data generation system 1 includes an image quality adjustment apparatus 7 connected to a camera 3, a test pattern generation apparatus 8 connected to the liquid crystal panel 2 and to the image quality adjustment apparatus 7, and a ROM writer 9 connected to the image quality adjustment apparatus 7. The image quality adjustment apparatus 7 includes a control unit 10, a captured image storage unit 11, a summed image storage unit 12, and a correction data storage unit 13.

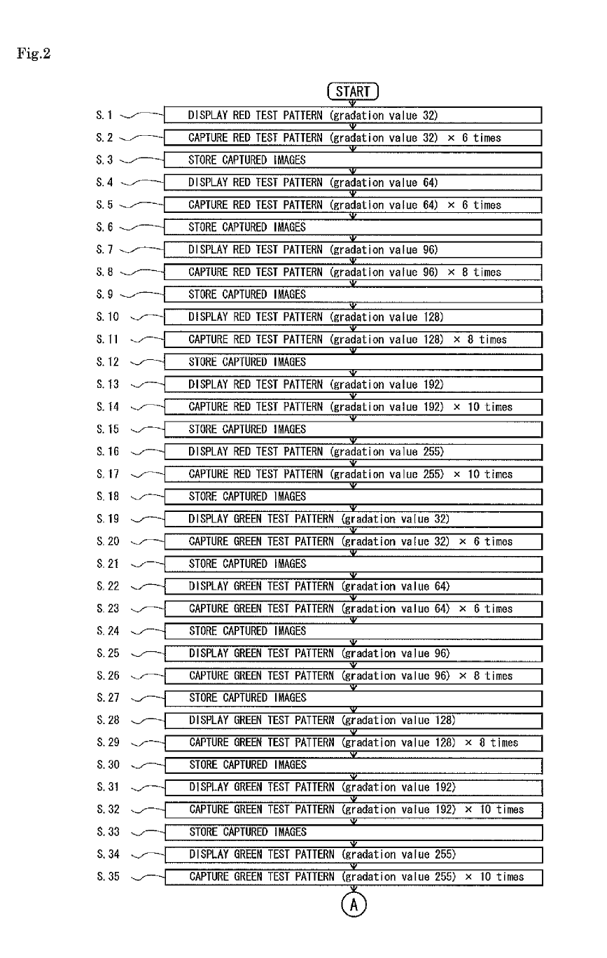

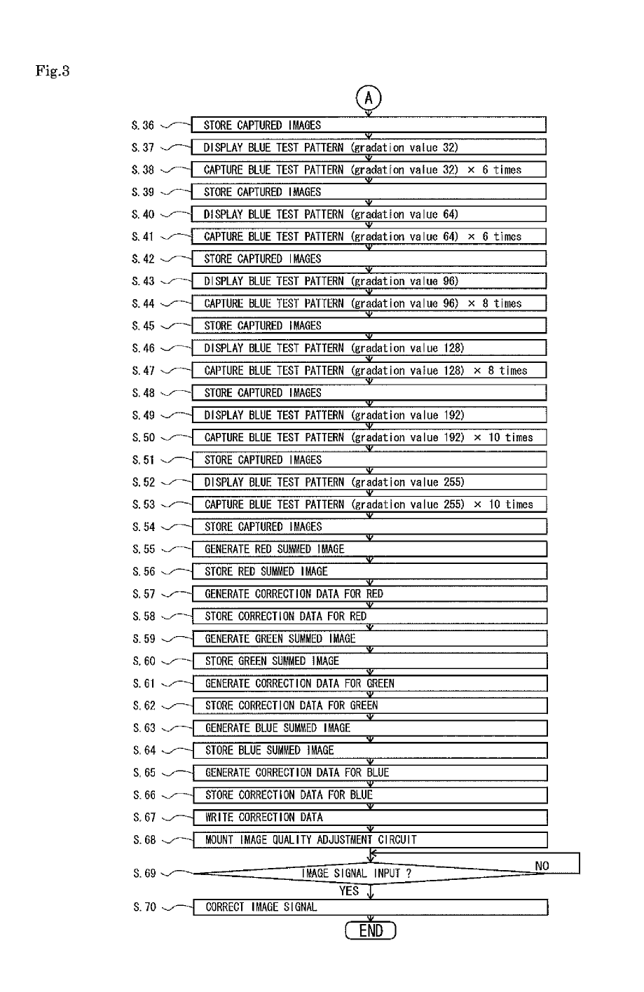

As illustrated in FIGS. 2 and 3, in order for the correction data generation system 1 to generate correction data, the control unit 10 in the image quality adjustment apparatus 7 first instructs the test pattern generation apparatus 8 to transmit an 8-bit test pattern display signal (R signal) to the liquid crystal panel 2 so as to display red test patterns on the liquid crystal panel 2 (step 1 (labeled “S. 1” in FIG. 2, the same applies below)). These red test patterns are realized by all pixels in the liquid crystal panel 2 displaying red. In step 1, red test patterns with a gradation value of 32 are displayed across the entire liquid crystal panel 2.

Next, the control unit 10 captures the liquid crystal panel 2 displaying the red test patterns with the camera 3 six times (step 2), and stores the captured images in the captured image storage unit 11 (step 3).

Subsequently, the control unit 10 instructs the test pattern generation apparatus 8 to change the gradation value of the red test patterns to 64 (step 4), captures the red test patterns with the camera 3 six times (step 5), and stores the captured images in the captured image storage unit 11 (step 6). Thereafter, the control unit 10 changes the gradation value of the red test patterns to 96 (step 7), captures the red test patterns with the camera 3 eight times (step 8), stores the captured images in the captured image storage unit 11 (step 9), changes the gradation value of the red test patterns to 128 (step 10), captures the red test patterns with the camera 3 eight times (step 11), stores the captured images in the captured image storage unit 11 (step 12), changes the gradation value of the red test patterns to 192 (step 13), captures the red test patterns with the camera 3 ten times (step 14), stores the captured images in the captured image storage unit 11 (step 15), changes the gradation value of the red test patterns to 255 (step 16), captures the red test patterns with the camera 3 ten times (step 17), and stores the captured images in the captured image storage unit 11 (step 18).

In a manner similar to steps 1 to 18, the control unit 10 instructs the test pattern generation apparatus 8 to transmit an 8-bit test pattern display signal (G signal) to the liquid crystal panel 2 so as to display green test patterns with a gradation value of 32 on the liquid crystal panel 2 (step 19), captures the green test patterns with the camera 3 six times (step 20), and stores the captured images in the captured image storage unit 11 (step 21). Thereafter; the control unit 10 changes the gradation value of the green test patterns to 64 (step 22), captures the green test patterns with the camera 3 six times (step 23), stores the captured images in the captured image storage unit 11 (step 24), changes the gradation value of the green test patterns to 96 (step 25), captures the green test patterns with the camera 3 eight times (step 26), stores the captured images in the captured image storage unit 11 (step 27), changes the gradation value of the green test patterns to 128 (step 28), captures the green test patterns with the camera 3 eight times (step 29), stores the captured images in the captured image storage unit 11 (step 30), changes the gradation value of the green test patterns to 192 (step 31), captures the green test patterns with the camera 3 ten times (step 32), stores the captured images in the captured image storage unit 11 (step 33), changes the gradation value of the green test patterns to 255 (step 34), captures the green test patterns with the camera 3 ten times (step 35), and stores the captured images in the captured image storage unit 11 (step 36).

Furthermore, the control unit 10 instructs the test pattern generation apparatus 8 to transmit an 8-bit test pattern display signal (B signal) to the liquid crystal panel 2 so as to display blue test patterns with a gradation value of 32 on the liquid crystal panel 2 (step 37), captures the blue test patterns with the camera 3 six times (step 38), stores the captured images in the captured image storage unit 11 (step 39), changes the gradation value of the blue test patterns to 64 (step 40), captures the blue test patterns with the camera 3 six times (step 41), stores the captured images in the captured image storage unit 11 (step 42), changes the gradation value of the blue test patterns to 96 (step 43), captures the blue test patterns with the camera 3 eight times (step 44), stores the captured images in the captured image storage unit 11 (step 45), changes the gradation value of the blue test patterns to 128 (step 46), captures the blue test patterns with the camera 3 eight times (step 47), stores the captured images in the captured image storage unit 11 (step 48), changes the gradation value of the blue test patterns to 192 (step 49), captures the blue test patterns with the camera 3 ten times (step 50), stores the captured images in the captured image storage unit 11 (step 51), changes the gradation value of the blue test patterns to 255 (step 52), captures the blue test patterns with the camera 3 ten times (step 53), and stores the captured images in the captured image storage unit 11 (step 54).

Once the control unit 10 has captured the red, green and blue test patterns, the control unit 10 generates a summed image for each gradation value (a summed image for the gradation value 32, a summed image for the gradation value 64, a summed image for the gradation value 96, a summed image for the gradation value 128, a summed image for the gradation value 192, and a summed image for the gradation value 255) by summing the captured images of the red test patterns stored in the captured image storage unit 11 for each gradation value (step 55), and stores each summed image in the summed image storage unit 12 (step 56). Then, for each gradation value, the control unit 10 generates correction data for reducing unevenness in luminance when displaying red on the liquid crystal panel 2 based on the corresponding summed image (step 57) and stores the generated correction data in the correction data storage unit 13 (step 58). The summed image for each gradation value is two-dimensional luminance distribution data for each gradation value. The control unit 10 can generate correction data (image correction table) by inverting the two-dimensional luminance distribution data.

In a manner similar to steps 55 to 58, the control unit 10 generates a summed image for each gradation value by summing the captured images of the green test patterns stored in the captured image storage unit 11 for each gradation value (step 59), and stores each summed image in the summed image storage unit 12 (step 60). Then, for each gradation value, the control unit 10 generates correction data for reducing unevenness in luminance when displaying green on the liquid crystal panel 2 based on the corresponding summed image stored in the summed image storage unit 12 (step 61) and stores the generated correction data in the correction data storage unit 13 (step 62).

The control unit 10 also generates a summed image for each gradation value by summing the captured images of the blue test patterns stored in the captured. image storage unit 11 for each gradation value (step 63), and stores each summed image in the summed image storage unit 12 (step 64). Then, for each gradation value, the control unit 10 generates correction data for reducing unevenness in luminance when displaying blue on the liquid crystal panel 2 based on the corresponding summed image stored in the summed image storage unit 12 (step 65) and stores the generated correction data in the correction data storage unit 13 (step 66).

The control unit 10 causes the ROM writer 9 to write the pieces of correction data used when displaying red, green and blue, which are stored in the correction data storage unit 13, into the ROM 5 (step 67). The liquid crystal panel 6 with image quality adjustment functions is completed by mounting the image quality adjustment circuit 4 including the ROM 5 on the liquid crystal panel 2 (step 68). When an image signal is input to this liquid crystal panel 6 with image quality adjustment functions (step 69), the image quality adjustment circuit 4 adds correction values to the input signal with reference to the pieces of correction data written into the ROM 5, thereby suppressing unevenness in display of the liquid crystal panel 2 (step 70).

In the present embodiment, test patterns are displayed on the liquid crystal panel 2 in units of colors and in units of specific gradation values, and the displayed test patterns are captured by the camera 3 a plurality of times. A summed image is generated for each specific gradation value by summing a plurality of captured images of the test patterns. Correction data is generated for each specific gradation value based on the corresponding summed image. As a result, highly accurate correction data can be generated while suppressing the influence of photon shot noise. More specifically, the following applies to all colors: for the gradation values 32 and 64, six captured images are summed, and therefore the S/N ratio of the summed image is 2.4 times larger than the S/N ratio of each captured image; for the gradation values 96 and 128, eight captured images are summed, and therefore the S/N ratio of the summed image is 2.8 times larger than the S/N ratio of each captured image; and for the gradation values 192 and 255, ten captured images are summed, and therefore the S/N ratio of the summed image is 3.2 times larger than the S/N ratio of each captured image. In this manner, correction data is generated based on a summed image that has a large S/N ratio. As a result, highly accurate correction data can be obtained while suppressing the influence of photon shot noise.

Furthermore, comparing any two sequential gradation values, the number of times the test patterns are captured for each gradation value is either the same therebetween, or larger for one gradation value that has higher luminance than for the other gradation value that has lower luminance (for example, comparing the gradation values 32 and 64, the number of times the test patterns are captured is the same therebetween, i.e. six; on the other hand, comparing the gradation values 64 and 96, the number of times the test patterns are captured is six for the gradation value 64 and eight for the gradation value 96, that is to say, larger for the gradation value 96 that has higher luminance than for the gradation value 64 that has lower luminance). Therefore, while the test patterns are captured a larger number of times for higher luminance that requires a short period of time for image capture and makes noise easily prominent, the test patterns are captured a smaller number of times for lower luminance that requires a long period of time for image capture and makes noise less prominent. Consequently, correction data that adequately has the effect of reducing noise through summation can be generated while suppressing the increase in the takt time.

Furthermore, comparing any two consecutive pairs of sequential gradation values, the difference between gradation values is either the same therebetween, or larger for one pair that has higher luminance than for the other pair that has lower luminance (for example, comparing a pair of gradation values 32 and 64 with a pair of gradation values 64 and 96, the difference between gradation values is the same therebetween, i.e. 32; on the other hand, comparing a pair of gradation values 96 and 128 with a pair of gradation values 128 and 192, the difference between gradation values is 32 in the former pair and 64 in the latter pair, that is to say, larger for the latter pair that has higher luminance than for the former pair that has lower luminance). In this way, the interval of image capture (the interval of luminance) is smaller for lower luminance that easily changes the form and distribution of unevenness in display when the luminance changes. Accordingly, even when correction data is calculated through interpolation for gradation values for which image capture is not performed, highly accurate correction data can be obtained.

As a signal input to the liquid crystal panel 2 is corrected based on the above correction data, unevenness in display of the liquid crystal panel 2 can be reduced effectively, and the image quality thereof can be adjusted with high accuracy and thus be improved.

### Embodiment 2

The present embodiment provides another method for generating correction data in the correction data generation system 1.

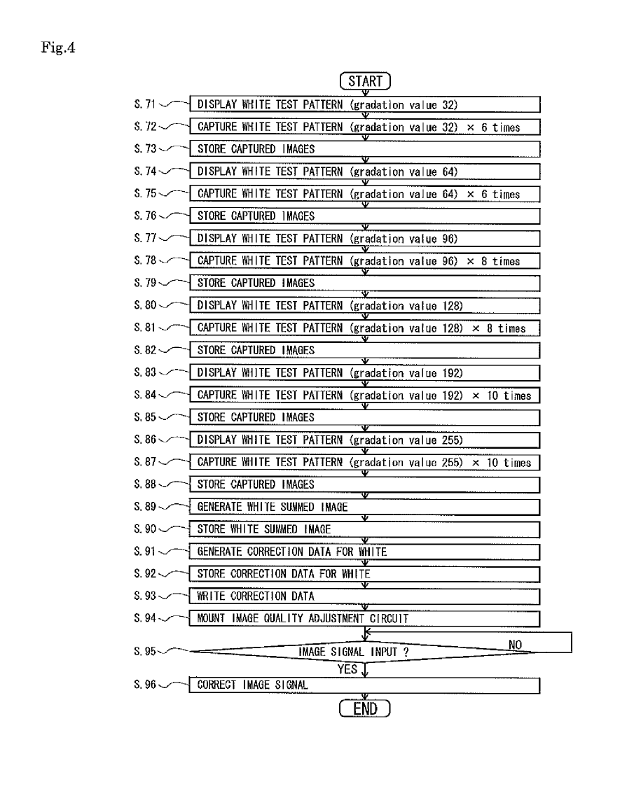

As illustrated in FIG. 4, the control unit 10 first instructs the test pattern generation apparatus 8 to transmit an 8-bit test pattern display signal (RGB signal) to the liquid crystal panel 2 so as to display white test patterns on the liquid crystal panel 2 (step 71). These white test patterns are realized by all pixels in the liquid crystal panel 2 displaying white (depending on the luminance, it may look gray) through emission of RGB light. In step 71, a white image (gray image) with a gradation value of 32 is displayed across the liquid crystal panel 2.

Next, the control unit 10 captures the liquid crystal panel 2 displaying the white test patterns with the camera 3 six times (step 72), and stores the captured images in the captured image storage unit 11 (step 73).

Subsequently, the control unit 10 changes the gradation value of the white test patterns to 64 (step 74), captures the white test patterns with the camera 3 six times (step 75), and stores the captured images in the captured image storage unit 11 (step 76). Thereafter, the control unit 10 changes the gradation value of the white test patterns to 96 (step 77), captures the white test patterns with the camera 3 eight times (step 78), stores the captured images in the captured image storage unit 11 (step 79), changes the gradation value of the white test patterns to 128 (step 80), captures the white test patterns with the camera 3 eight times (step 81), stores the captured images in the captured image storage unit 11 (step 82), changes the gradation value of the white test patterns to 192 (step 83), captures the white test patterns with the camera 3 ten times (step 84), stores the captured images in the captured image storage unit 11 (step 85), changes the gradation value of the white test patterns to 255 (step 86), captures the white test patterns with the camera 3 ten times (step 87), and stores the captured images in the captured image storage unit 11 (step 88).

Once the control unit 10 has captured the white test patterns, the control unit 10 generates a summed image for each gradation value by summing the captured images of the white test patterns stored in the captured image storage unit 11 for each gradation value (step 89), and stores each summed image in the summed image storage unit 12 (step 90). Then, for each gradation value, the control unit 10 generates correction data for reducing unevenness in luminance when displaying white on the liquid crystal panel 2 based on the corresponding summed image (step 91) and stores the generated correction data in the correction data storage unit 13 (step 92).

The control unit 10 causes the ROM writer 9 to write the pieces of correction data used when displaying white, which are stored in the correction data storage unit 13, into the ROM 5 (step 93). The liquid crystal panel 6 with image quality adjustment functions is completed by mounting the image quality adjustment circuit 4 including the ROM 5 on the liquid crystal panel 2 (step 94). When an image signal is input to this liquid crystal panel 6 with image quality adjustment functions (step 95), the image quality adjustment circuit 4 adds correction values to the input signal with reference to the pieces of correction data written into the ROM 5, thereby suppressing unevenness in the luminance of the liquid crystal panel 2 (step 96).

In the present embodiment, unlike Embodiment 1, correction data is not generated for each of red, green and blue; instead, correction data is generated, only for white. As a result, the number of times the test patterns are captured is one third the number of times the test patterns are captured in Embodiment 1, and therefore the takt time can be reduced. In particular, when the liquid crystal panel 2 does not exhibit unevenness in color but exhibits unevenness in luminance, the method of the present embodiment can adequately improve the image quality.

Although the above has described exemplary embodiments of the present invention, the present invention is not limited to the above embodiments and may be modified as appropriate without departing from the concept of the present invention.

For example, a display panel used in the adjustment of the image quality is not limited to a liquid crystal panel, and may instead be an organic EL panel, a plasma display panel (PDP), a projector, or the like.

The camera is not limited to a black-and-white camera, and may instead be a color camera. Also, the gradation values used in image capture and the number of times image capture is performed are not limited to the ones described above (the number of times image capture is performed may be one, and summation may not be performed for some gradation values). Furthermore, test patterns may not necessarily be displayed across the entire display panel as long as they show at least a part of unevenness in display of the display panel.

Moreover, alignment patterns (e.g. an image in which dots are arranged) may be displayed at predetermined positions on the display panel and captured by a camera. In this case, test patterns may be captured after checking the positions of images of the alignment patterns on an imaging surface of the camera. This makes it possible to accurately know the position on the imaging surface of the camera where each region of the display panel is shown (the pixel where each region of the display panel is shown), and therefore to generate correction data of higher accuracy

### REFERENCE SIGNS LIST

1 CORRECTION DATA GENERATION SYSTEM
2 LIQUID CRYSTAL PANEL (DISPLAY PANEL)
3 CAMERA
4 IMAGE QUALITY ADJUSTMENT CIRCUIT (IMAGE QUALITY ADJUSTMENT MEANS)
5 ROM (STORAGE UNIT)
6 LIQUID CRYSTAL PANEL (DISPLAY PANEL) WITH IMAGE QUALITY ADJUSTMENT FUNCTIONS
7 IMAGE QUALITY ADJUSTMENT APPARATUS (DISPLAY CONTROL MEANS, SUMMED IMAGE GENERATION MEANS, CORRECTION DATA GENERATION MEANS)
8 TEST PATTERN GENERATION APPARATUS
9 ROM WRITER
10 CONTROL UNIT
11 CAPTURED IMAGE STORAGE UNIT
12 SUMMED IMAGE STORAGE UNIT
13 CORRECTION DATA STORAGE UNIT

1. A correction data generation method for generating correction data by capturing a display panel with a camera, the correction data being for reducing unevenness in display of the display panel by correcting a signal input to the display panel, the method comprising:
a capturing step of displaying test patterns on the display panel in units of specific gradation values, and capturing the test patterns with the camera a plurality of times for each specific gradation value;
a summed image generating step of generating, for each specific gradation value, a summed image by summing a plurality of captured images of the test patterns; and
a correction data generating step of generating the correction data for each specific gradation value based on the corresponding summed image.

2. The correction data generation method according to claim 1, wherein
the number of times the test patterns are captured for each specific gradation value is either the same between any two sequential gradation values, or larger for one of the sequential gradation values that has higher luminance than for the other that has lower luminance.

3. The correction data generation method according to claim 1, wherein
three or more gradation values are set as the specific gradation values, and a difference between any two sequential gradation values is either the same between two consecutive pairs of sequential gradation values, or larger for one of the consecutive pairs that has higher luminance than for the other that has lower luminance.

4. A correction data generation system for generating correction data by capturing a display panel with a camera, the correction data being for reducing unevenness in display of the display panel by correcting a signal input to the display panel, the system comprising:
a display control means that displays test patterns on the display panel in units of specific gradation values;
a summed image generation means that generates a summed image for each specific gradation value by summing a plurality of captured images obtained by the camera capturing the test patterns a plurality of times for each specific gradation value; and
a correction data generation means that generates the correction data for each specific gradation value based on the corresponding summed image.

5. The correction data generation system according to claim 4, wherein
the number of times the test patterns are captured for each specific gradation value is either the same between any two sequential gradation values, or larger for one of the sequential gradation values that has higher luminance than for the other that has lower luminance.

6. The correction data generation system according to claim 4, wherein
three or more gradation values are set as the specific gradation values, and a difference between any two sequential gradation values is either the same between two consecutive pairs of sequential gradation values, or larger for one of the consecutive pairs that has higher luminance than for the other that has lower luminance.

7. An image quality adjustment method for adjusting image quality of a display panel using correction data for reducing unevenness in display of the display panel through correction of a signal input to the display panel, the method comprising:
a capturing step of displaying test patterns on the display panel in units of specific gradation values, and capturing the test patterns with the camera a plurality of times for each specific gradation value;
a summed image generating step of generating, for each specific gradation value, a summed image by summing a plurality of captured images of the test patterns;
a correction data generating step of generating the correction data for each specific gradation value based on the corresponding summed image; and
an input signal correcting step of correcting the signal input to the display panel based on the correction data.

8. The image quality adjustment method according to claim 7, wherein
the number of times the test patterns are captured for each specific gradation value is either the same between any two sequential gradation values, or larger for one of the sequential gradation values that has higher luminance than for the other that has lower luminance.

9. image quality adjustment method according to claim 7, wherein
three or more gradation values are set as the specific gradation values, and a difference between any two sequential gradation values is either the same between two consecutive pairs of sequential gradation values, or larger for one of the consecutive pairs that has higher luminance than for the other that has lower luminance.

10. A method for manufacturing a display panel with image quality adjustment functions including a display panel and an image quality adjustment means provided with a storage having stored therein correction data for reducing unevenness in display of the display panel through correction of a signal input to the display panel, the method comprising:
a capturing step of displaying test patterns on the display panel in units of specific gradation values, and capturing the test patterns with the camera a plurality of times for each specific gradation value;
a summed image generating step of generating, for each specific gradation value, a summed image by summing a plurality of captured images of the test patterns;
a correction data generating step of generating the correction data for each specific gradation value based on the corresponding summed image;
a correction data storing step of storing the correction data in the storage; and
a mounting step of mounting the image quality adjustment means on the display panel so that the image quality adjustment means corrects the signal input to the display panel based on the correction data.

11. The method, for manufacturing the display panel with image quality adjustment functions according to claim 10, wherein
the number of times the test patterns are captured for each specific gradation value is either the same between any two sequential gradation values, or larger for one of the sequential gradation values that has higher luminance than for the other that has lower luminance.

12. The method for manufacturing the display panel with image quality adjustment functions according to claim 10, wherein
three or more gradation values are set as the specific gradation values, and a difference between any two sequential gradation values is either the same between two consecutive pairs of sequential gradation values, or larger for one of the consecutive pairs that has higher luminance than for the other that has lower luminance.

13. A display panel with image quality adjustment functions including a display panel and an image quality adjustment means provided with a storage having stored therein correction data for reducing unevenness in display of the display panel through correction of a signal input to the display panel, wherein
test patterns are displayed on the display panel in units of specific gradation values, the test patterns are captured by a camera a plurality of times for each specific gradation value, a summed image is generated for each specific gradation value by summing a plurality of captured images of the test patterns, and the correction data is generated for each specific gradation values based on the corresponding summed image.

14. The display panel with image quality adjustment functions according to claim 13, wherein
the number of times the test patterns are captured for each specific gradation value is either the same between any two sequential gradation values, or larger for one of the sequential gradation values that has higher luminance than for the other that has lower luminance.

15. The display panel with image quality adjustment functions according to claim 13, wherein
three or more gradation values are set as the specific gradation values, and a difference between any two sequential gradation values is either the same between two consecutive pairs of sequential gradation values, or larger for one of the consecutive pairs that has higher luminance than for the other that has lower luminance.
